(19) United States
(12) Patent Application Publication
(10) Pub. No.: US 2005/0175407 A1
(43) Pub. Date: Aug. 11, 2005

(54) Joining element for releasable joining of partially overlapping parts, as well as a housing having such a joining element, and a method for releasable joining of at least partially overlapping parts

(75) Inventor: Otto Demel, Heidelberg (DE)

Correspondence Address: LEYDIG VOIT & MAYER, LTD, 700 THIRTEENTH ST. NW, SUITE 300, WASHINGTON, DC, 20005-3960, US

(73) Assignee: Lisi Automotive Rapid, Puiseux Pontoise (FR)

(21) Appl. No.: 11/040,092

(22) Filed: Jan. 24, 2005

(30) Foreign Application Priority Data
Feb. 5, 2004 (EP) 04 290 300.5

(51) Int. Cl. F16D 1/00

(52) U.S. Cl. 403/408.1

(57) ABSTRACT

The invention concerns a joining element for releasable joining of at least two plate-like, at least partially overlapping parts in a joining region. The element has a cover mounted on the parts being joined, and a spring-loaded clip that passes through the cover and the parts being joined, forcing the cover against the parts.

The present invention concerns a joining element for releasable joining of at least two plate-like, at least partially overlapping parts in a joining region according to the preamble of claim 1, as well as a housing having such a joining element according to the preamble of claim 7, and a method for releasable joining of at least two plate-like, at least partially overlapping parts in a joining region according to the preamble of claim 8.

The term “housing” according to the invention is to be understood, in the context of the present invention, to mean different structures, like a switch cabinet for an electronic device, a housing of a device and an autobody of a vehicle, if they are subject to equivalent loads, for example, vibrations, based on their area of application.

All these housings involve fastening of one or more plate-like parts to a flat, plate-like part of a base structure, at least in the fastening or joining region. Fastening is supposed to be vibration-proof and not laid out as a screw connection, because such a connection is very costly in a vibration-proof version.

Another reason that the present invention can find application in very different technical fields lies in the common practical requirement to be met in these different fields for rapid removability of the parts, since cover plates or cowlings must be quickly removable in the context of maintenance work.

The underlying task of the invention is therefore to propose a joining element, suitable for releasably joining parts to each other, that are formed plate-like, at least in a joining region, and at least partially overlap.

This task is accomplished with the features of the characterizing part of claim 1. The task is also accomplished by a housing, having the joining element according to claim 1, as well as by a method for releasable joining of parts according to the characterizing features of claim 8.

The joining element according to the invention has two components, namely a cover, which is mounted on the parts to be joined together, and a clip, which passes through the cover and the parts being joined to each other, in order to force the cover onto the parts. The clip is spring-elastic for this purpose.

The cover, which can be rectangular, and also round, has a peripheral bridge in order to create a space between the main surface of the cover and the first of the parts being joined on which the cover is mounted, into which space the clip can engage. Advantageously, but not necessarily, the bridge forms an edge of the cover. Access to the aforementioned space occurs for the clip via two slits in the main surface of the cover at a spacing from each other and parallel to each other.

The clip of the joining element according to the invention is formed from a strip-like, elastic material in a roughly U-shape and has two arms of different length, the longer arm of which passes through the cover and all the parts being joined together, and the shorter arm of which only passes through the cover.

The clip can be produced, both from spring steel, and also from a largely rupture-proof, sufficiently elastic plastic.

Additional features and advantages of the invention are apparent from the following description of an embodiment of the invention. The description is made with reference to the accompanying drawings, in which:

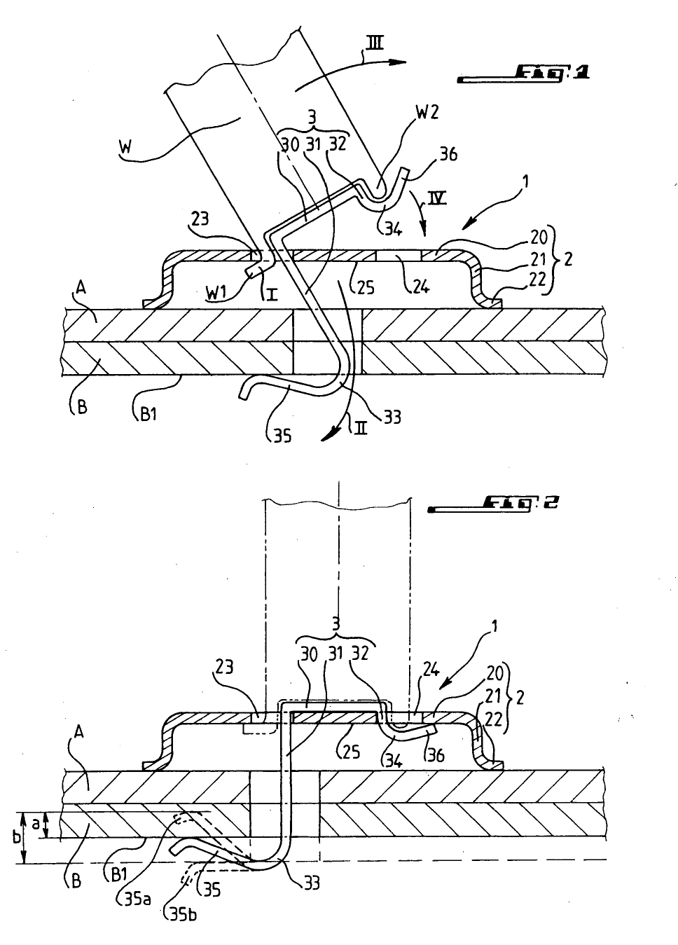

FIGS. 1 and 2 show a joining element according to the invention and two parts connected to it in a longitudinal section, FIG. 1 specifically during the joining process and Figure at the end of the process;

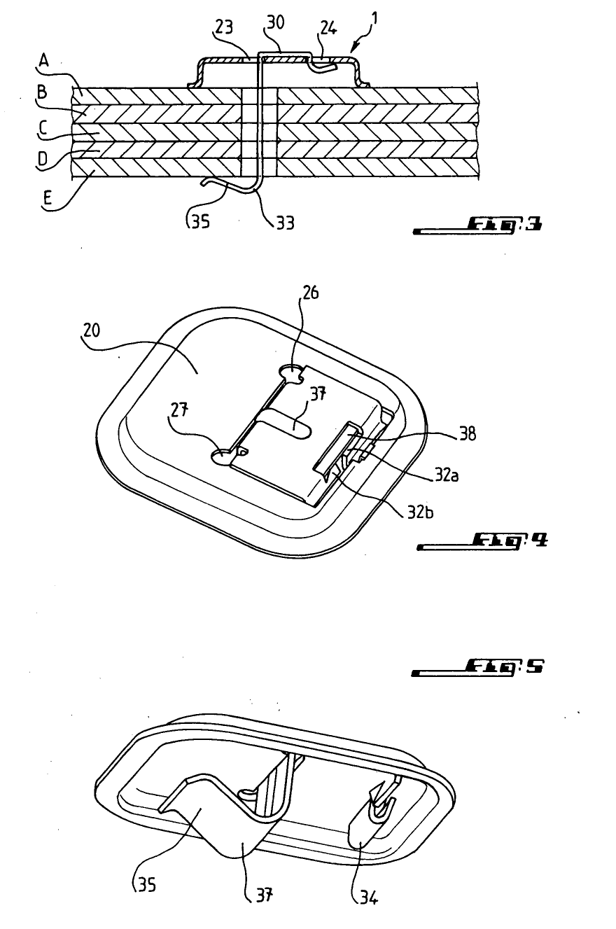

FIG. 3 shows a joining element according to the invention and five parts joined to it in longitudinal section;

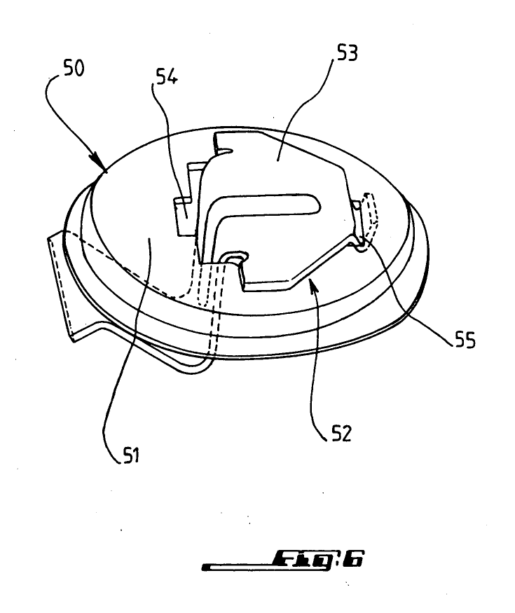

FIGS. 4 and 5 show the joining element of FIG. 1 in an oblique top view and oblique bottom view and

FIG. 6 shows a round variant of the joining element of FIG. 1.

The joining element 1 according to the invention, depicted in FIGS. 1 and 2 in a longitudinal section, is used, for example, for releasable joining of two partially overlapping parts A, B. It consists of a cover 2, to be mounted on parts A, B being joined together, and a clip 3 that passes through the cover and parts A, B. Whereas FIG. 1 shows the joining element during a joining process, FIG. 2 represents the joining element at the end of the process.

To produce the connection between the two parts A and B, the cover 2 is mounted on one of the two parts in a region in which they overlap, and the clip 3 is passed through the cover and parts A, B until it snaps in, in a manner described further below.

Cover 2 has a flat part forming a cover surface 20 and a peripheral bridge 21, which forms the outer edge of the cover and lies directly against cover surface 20. Edge 21 grades into an outward extending peripheral section 22, designed so that it forms a spring element of cover 2 with edge 21. The spring force of the spring element is dimensioned, so that the cover 2 has sufficient compliance, in order to permit insertion of clip 3, but then applies sufficient restoring force, in order to tighten clip 3 in a manner described further below.

The cover 2 also has two parallel, spaced slits 23, 24 in cover surface 20, through which the clip 3 is passed.

The clip 3 is produced from a sheet-like, elastic material, advantageously spring steel, and formed roughly U-shaped. The clip 3 has two arms 31, 32 of different length that are connected to each other via a transverse section 30 on one end. The two arms 31, 32 are bent back on their other free ends 33, 34, in order to form spring elements with the sections 35, 36 connected to them, thanks to which the longer arm 31 is elastically supported on the side B1 of part B facing away from cover 2, and the shorter arm 32 is supported elastically on the inside 25 of cover 2.

FIG. 3 shows the case, in which a total of five parts are joined together, for example, a protective plate A with an additional protective plate C with corresponding damping plates B and D, which are fastened on a frame part or auto body part E. The arrangement is thus conceived, so that the damping plate B is arranged between the protective plate A and the protective plate C and the damping plate D between the protective plate C and the auto body part B. The protective plates A, C form a continuous protective surface of a frame box or vehicle body. The entire thickness of this arrangement exceeds that of the arrangement according to FIG. 2 significantly. The difference resulting for the joining element 1 mostly concerns the clip 3, specifically the required effective length of the longer arm 31. This can be obtained in two different ways.

According to the method apparent from FIG. 3, the required larger effective length of arm 31 is achieved, in that the arm itself is designed longer. Optionally, the larger arm length requires a somewhat greater width of slit 23, in order to be able to insert clip 3 without problem.

According to the method apparent from FIG. 2, the effective length of arm 31, however, can also be changed by loading the arm over the elastic region. In FIG. 2, the thickness of part B, which is connected to part A, is shown with three different dimensions. The middle thickness of part B is shown by the solid line, representing bottom B1. The cases of lower and larger thickness of part B are shown by the dashed lines, on which lie the ends 35a and 35b of arm 31 also shown with dashed lines.

In the case of smaller thickness of part B, the end of arm 31 of clip 3 is hardly deformed at all elastically, in order to lie rigidly against the bottom of part B. The free end of arm 31 then occupies the position marked 35a.

If part B assumes the thickness stated as the middle dimension, which is greater by amount a than the small thickness, the free end of arm 31 is elastically deformed and assumes the position marked 35.

If part B assumes the thickness stated as the largest dimension, which is larger by an amount b than the small thickness, the free end of arm 31 is plastically stressed over the elastic region, but only to the extent that no permanent deformation occurs, but an elastic residual spring force remains. The free end 35b is then stressed only to the extent that the angle included between the free end 35b and arm 31, depending on the elastic properties of the material in clip 3, is not a right angle, or at least does not significantly exceed a right angle.

In the application examples depicted in FIGS. 1 to 3, the clip 3 depicted in FIGS. 4 and 5 is used. Insertion of clip 3 then occurs in the manner apparent from FIG. 1.

Initially, the cover 2 is placed on the parts A, B being joined to each other, these parts having first been provided with a slit 23a that passes through both parts, which is at least as long as the slit 23 of cover 2, and wider than this slit 23. The width of slit 23a is chosen, so that the arm 31 of clip 3 can be passed through in its finally formed stress-free state (operation I). For insertion of arm 31, the cover 2 is set up, so that the slit 23 is offset relative to slit 23a in the manner shown in FIG. 1.

The shorter arm 23 is then pushed into the slit 24 of cover 2 until it snaps in (operations II and III). The clip 3 is then pivoted from its oblique insertion position into the vertical locking and tightening position.

Insertion of clip 3, and especially pivoting of clip 3, during which the cover 2 is shifted so that the slit 23 comes to lie above slit 23a, is advantageously conducted with a tool W.

The tool W, designed essentially rod-like, has two hook-like structures W1 on the end of one edge to be mounted on clip 3, and two tabs W2 running in the longitudinal direction of tool W on the opposite edge. The tool W is inserted with the structures W1 into holes 26, 27 of the cover surface 20. The distance between the hook-like structures W1 and tabs W2 corresponds to the width of the transverse section 30 of clip 3.

As is apparent in FIG. 4, the holes 26, 27 are made in the extension of slit 23 of cover 2 on both sides. This variant avoids having to design the slit 23 needlessly wide. In addition, FIG. 4, together with FIG. 5, shows that the clip 3 is advantageously provided with a stabilizing stiffening rib 37, that runs in the center in the longitudinal direction of clip 3 roughly from the middle of the transverse part 30 of clip 3 to the end of the part of the arm 31 of clip 3 that is not bent back. An angular rigidity between the transverse part 30 and the longer arm 31 of clip 3 is achieved by this.

The spring force of arm 31, required to achieve the tightening effect, therefore comes only from the elastically deformable end section 35 of the longer arm 31 of clip 3. In order for the connection element 1 to be used to connect two or more plates with different total thickness, without loading the clip beyond the elastic deformation range and without the pressing force of arm 31 relaxing because of material fatigue, because the arm is loaded up to the elastic deformation limit, the clip 3 can advantageously be made in two or more variants with an arm 31 in different lengths.

Formation of the shorter arm 32 of clip 3 differs significantly from that of the longer arm 31. On the one hand, this is due to the fact that the arm 32 is much shorter, since it only has to pass through cover 2, and, in addition, is supposed to snap in right on the inside of cover 2. On the other hand, the arm 32, however, has the task of releasable snapping in of clip 3. For this purpose, the shorter arm 32, as is apparent from FIG. 4, has an essentially T-shape recess 38. Thanks to this recess 38, the arm 32 is divided into two sections 32a, 32b in a short region. In this case, one of the two sections, section 32b in FIG. 4, is bent toward longer arm 31, so that the clip 3, after snapping in of arm 32, is additionally secured under cover 2.

To release locking, the section 32b is brought beneath cover 2 by elastic deformation with a small screwdriver and the bent back section 36 of the small arm 32 is also brought beneath cover 2 and the clip 3 disengaged from cover 2. The clip 3 is then pulled out through the slit 23a of the joined parts A, B and the slit 23 of cover 2. Finally, cover 2 is removed from part A.

FIG. 6 shows a variant of the joining element 1 according to the invention, the joining element 50 with round cover 51. The design of the joining element 50 essentially corresponds to that of the joining element 1. The essential difference is due to the round cover shape in the design of clip 52, which has an essentially trapezoidal transverse part 53.

Whereas the cover 2 in joining element 1 has two roughly equally long slits, the cover 51 of joining element 50 has a longer slit 54 to accommodate the longer arm of clip 52 and a shorter slit 55 to accommodate the shorter arm of clip 52.

The method for producing a releasable connection with at least one joining element 50 is the same as in the previously described method using a joining element 1.

Release of the connection of at least two parts occurs accordingly, these parts being connected by a joining element 50, the method for releasing of a joint produced with a joining element 1 also being further described above.

1. A joining element for releasable joining of at least two plate-like, at least partially overlapping parts in a joining region, the joining element comprising:
a cover, and
a spring-loaded clip that passes through the cover and the parts being joined together, pressing of the cover against the parts.

2. The joining element according to claim 1, wherein the cover has a peripheral bridge and two parallel, spaced slits to accommodate the clip.

3. The joining element according to claim 1, wherein the clips is a strip-like spring material in a generally U-shape, having two arms of different lengths with free ends having reverse bends, the longer arm being dimensioned to pass through the cover and the parts being joined to each other, by elastic support on the part facing away from the cover, and the shorter arm is dimensioned, to pass through the cover but not the parts and be elastically supported on an inside surface of the cover.

4. The joining element according to claims 9, wherein the shorter arm of the clip is dimensioned so that the parts are releasable by engagement of the clip through the one of the slits of the cover through which the shorter arm of the clip passes.

5. The joining element according to claim 1, wherein the clip is made of steel.

6. The joining element according to claim 1, wherein the clip is made of plastic.

7. A housing including a joining element according to claim 1.

8. A method of releasable joining of at least two plate-like, at least partially overlapping parts with a joining element comprising:
mounting of a cover on the parts to be joined together, the parts including a slit passing through the parts, the slit being as long as, but wider than a first slit in the cover,
inserting a longer arms of the joining element through the first slit in the cover and the slit penetrating the parts and
forcing a shorter arm of the joining element into a second slit in the cover and snapping in the shorter arm.

9. The joining element according to claim 2, wherein the clip is a strip-like spring material in a generally U-shape, having two arms of different lengths with free ends having reverse bends, the longer arm being dimensioned to pass through the cover and the parts being joined to each other, by elastic support on the part facing away from the cover, and the shorter arm is dimensioned to pass through the cover but not the parts and be elastically supported on an inside surface of the cover.
